(19) United States
(12) Patent Application Publication
(10) Pub. No.: US 2026/0154783 A1
(43) Pub. Date: Jun. 4, 2026

(54) COMPUTING DEVICE, COMPUTING METHOD, COMPUTING PROGRAM, AND WAVEFRONT SENSOR

(71) Applicant: Tamron Co., Ltd., Saitama (JP)

(72) Inventor: Suguru MIYAGAWA, Saitama (JP)

(73) Assignee: Tamron Co., Ltd., Saitama (JP)

(21) Appl. No.: 19/319,604

(22) Filed: Sep. 4, 2025

(30) Foreign Application Priority Data
Dec. 3, 2024 (JP) 2024-210715

(51) Int. Cl. G06T 5/10; G02B 3/00

(52) U.S. Cl. CPC G06T 5/10; G02B 3/0037

(57) ABSTRACT

A reciprocal lattice image, which represents a lattice point group of a reciprocal lattice, is generated by performing a two-dimensional Fourier transform on a target image. In addition, a target lattice, in which an arrangement of the lattice point group approximates an arrangement of a target focal spot group, is estimated with reference to a lattice vector of the reciprocal lattice. Then, lattice coordinates of a lattice point, which is closest to a target focal spot, of the target lattice are assigned to each corresponding target focal spot, thereby pairing the target focal spot with a reference focal spot.

### CROSS-REFERENCE TO RELATED APPLICATIONS

This application is based on and claims the benefit of priority from Japanese Patent Application No. 2024-210715, filed on Dec. 3, 2024, the entire contents of which are incorporated herein by reference.

### BACKGROUND OF THE INVENTION

### Technical Field

The present invention relates to a computing device, a computing method, and a computing program for calculating a wavefront aberration amount. The present invention also relates to a wavefront sensor including such a computing device.

### Related Art

As a device for measuring a wavefront aberration of light, a Shack-Hartmann-type wavefront sensor is known. In a Shack-Hartmann-type wavefront sensor, the wavefront aberration of a target light to be measured is measured based on a target image representing a target focal spot group which is obtained by applying a microlens array to the target light and a reference image representing a reference focal spot group which is obtained by applying a microlens array to a reference light, which is collimated light. Specifically, the target focal spot and the reference focal spot formed by the same microlens are paired, and the movement amount from the reference focal spot to the target focal spot is determined for each pair. Then, based on the movement amount for each pair, a wavefront aberration amount of the target light, such as a Zernike coefficient, is calculated. The term “movement amount from the reference focal spot to the target focal spot” refers to the movement amount when the position of the reference focal spot is regarded as the starting point and the position of the target focal spot is regarded as the endpoint.

As a method for pairing the reference focal spot and the target focal spot, for example, the following method is known. In this method, the reference image and the target image are divided into a plurality of blocks by vertical and horizontal grid lines arranged at equal intervals, and the reference focal spot and the target focal spot belonging to the same block are paired. When the wavefront aberration of the target light is small, the reference focal spot and the target focal spot formed by the same microlens satisfy the condition of belonging to the same block, and can therefore be paired. However, when the wavefront aberration of the target light becomes large, the movement amount from the reference focal spot to the target focal spot also becomes large. As a result, it becomes impossible to pair the reference focal spot and the target focal spot using the above-described method. This is because, when the movement amount becomes large, the target focal spot moves outside the block to which the corresponding reference focal spot belongs, and thus the premise that “the reference focal spot and the target focal spot formed by the same microlens belong to the same block” no longer holds. Typical cases in which the wavefront aberration becomes so large that pairing is no longer possible include cases where the target light is strongly defocused and cases where the target light includes strong astigmatism.

As a technique for addressing such a problem, a wavefront sensor described in JP 2010-261810 A is known. According to the wavefront sensor described in JP 2010-261810 A, it is possible to pair reference focal spots and target focal spots even in cases where the target light is strongly defocused.

However, the technique described in JP 2010-261810 A enables pairing between reference focal spots and target focal spots only when the arrangement direction of the target focal spots satisfies a condition of being parallel to the vertical and horizontal grid lines of a target image. This condition is satisfied, for example, when the target light is defocused, but not satisfied, for example, when the target light includes astigmatism. Therefore, the technique described in JP 2010-261810 A is applicable, for example, when the target light is defocused, but is not applicable, for example, when the target light includes astigmatism.

One aspect of the present invention has been made in view of the above problem, and an object thereof is to provide a technique capable of calculating a wavefront aberration amount even when an arrangement of target focal spots does not satisfy the condition of being parallel to the vertical and horizontal grid lines of a target image.

### SUMMARY OF THE INVENTION

A computing device according to one aspect of the present invention is configured to execute: a reference focal spot detection process that refers to a reference image representing a reference focal spot group formed by applying a microlens array to a reference light and detects each reference focal spot belonging to the reference focal spot group; a target focal spot detection process that refers to a target image representing a target focal spot group formed by applying the microlens array to a target light and detects each target focal spot belonging to the target focal spot group; a Fourier transform process that performs a two-dimensional Fourier transform on the target image to generate a reciprocal lattice image representing a lattice point group of a reciprocal lattice; a reciprocal lattice vector derivation process that refers to the reciprocal lattice image generated in the Fourier transform process and derives a lattice vector of the reciprocal lattice; a target lattice estimation process that refers to the lattice vector of the reciprocal lattice derived in the reciprocal lattice vector derivation process and estimates a target lattice in which an arrangement of the lattice point group approximates an arrangement of the target focal spot group; focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of the lattice point group approximates an arrangement of the reference focal spot group, and then (c) pairing a target focal spot and a reference focal spot to which identical lattice coordinates have been assigned; a focal spot movement amount derivation process that derives, for each pair formed in the focal spot pairing, a movement amount from a reference focal spot forming the pair to a target focal spot forming the pair; and a wavefront aberration amount derivation process that refers to each movement amount derived in the focal spot movement amount derivation process and derives a wavefront aberration amount representing a wavefront aberration of the target light.

A computing method according to one aspect of the present invention includes: a reference focal spot detection process that refers to a reference image representing a reference focal spot group formed by applying a microlens array to a reference light and detects each reference focal spot belonging to the reference focal spot group; a target focal spot detection process that refers to a target image representing a target focal spot group formed by applying the microlens array to a target light and detects each target focal spot belonging to the target focal spot group; a Fourier transform process that performs a two-dimensional Fourier transform on the target image to generate a reciprocal lattice image representing a lattice point group of a reciprocal lattice; a reciprocal lattice vector derivation process that refers to the reciprocal lattice image generated in the Fourier transform process and derives a lattice vector of the reciprocal lattice; a target lattice estimation process that refers to the lattice vector of the reciprocal lattice derived in the reciprocal lattice vector derivation process and estimates a target lattice in which an arrangement of the lattice point group approximates an arrangement of the target focal spot group; focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of the lattice point group approximates an arrangement of the reference focal spot group, and then (c) pairing a target focal spot and a reference focal spot to which identical lattice coordinates have been assigned; a focal spot movement amount derivation process that derives, for each pair formed in the focal spot pairing, a movement amount from a reference focal spot forming the pair to a target focal spot forming the pair; and a wavefront aberration amount derivation process that refers to each movement amount derived in the focal spot movement amount derivation process and derives a wavefront aberration amount representing a wavefront aberration of the target light.

A computing program according to one aspect of the present invention causes at least one processor to execute: a reference focal spot detection process that refers to a reference image representing a reference focal spot group formed by applying a microlens array to a reference light and detects each reference focal spot belonging to the reference focal spot group; a target focal spot detection process that refers to a target image representing a target focal spot group formed by applying the microlens array to a target light and detects each target focal spot belonging to the target focal spot group; a Fourier transform process that performs a two-dimensional Fourier transform on the target image to generate a reciprocal lattice image representing the lattice point group of a reciprocal lattice; a reciprocal lattice vector derivation process that refers to the reciprocal lattice image generated in the Fourier transform process and derives a lattice vector of the reciprocal lattice; a target lattice estimation process that refers to the lattice vector of the reciprocal lattice derived in the reciprocal lattice vector derivation process and estimates a target lattice in which an arrangement of the lattice point group approximates an arrangement of the target focal spot group; focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of a lattice point group approximates an arrangement of the reference focal spot group, and then (c) pairing a target focal spot and a reference focal spot to which identical lattice coordinates have been assigned; a focal spot movement amount derivation process that derives, for each pair formed in the focal spot pairing, a movement amount from a reference focal spot forming the pair to a target focal spot forming the pair; and a wavefront aberration amount derivation process that refers to each movement amount derived in the focal spot movement amount derivation process and derives a wavefront aberration amount representing a wavefront aberration of the target light.

### Effect of the Invention

According to one aspect of the present invention, it is possible to calculate a wavefront aberration amount even when an arrangement of target focal spots does not satisfy a condition of being parallel to the vertical and horizontal grid lines of a target image.

### BRIEF DESCRIPTION OF THE DRAWINGS

FIG. 1 is a schematic diagram illustrating one example of a reference image representing a reference focal spot group;

FIG. 2 is a schematic diagram illustrating one example of a target image representing a target focal spot group;

FIG. 3 is another schematic diagram illustrating one example of a target image representing a target focal spot group;

FIG. 4 is a block diagram illustrating a configuration of a computing device according to one embodiment of the present invention;

FIG. 5 is a flowchart illustrating a flow of a computing method according to one embodiment of the present invention;

FIGS. 6A to 6C are diagrams illustrating specific examples of an original target image, a simplified target image, and a reciprocal lattice image used in the computing method illustrated in FIG. 5;

FIG. 7 is a block diagram illustrating a main part configuration of a wavefront sensor according to one embodiment of the present invention;

FIG. 8 is a block diagram illustrating a first modification of the wavefront sensor illustrated in FIG. 7;

FIG. 9 is a block diagram illustrating a second modification of the wavefront sensor illustrated in FIG. 7;

FIG. 10 is a block diagram illustrating a third modification of the wavefront sensor illustrated in FIG. 7;

FIG. 11 is a diagram illustrating a reference image acquired through a reference image acquisition process by the wavefront sensor illustrated in FIG. 7;

FIG. 12A is a diagram illustrating a target image acquired through a target image acquisition process by the wavefront sensor illustrated in FIG. 7; FIG. 12B is a diagram illustrating a simplified target image generated through a target image simplification process by the wavefront sensor illustrated in FIG. 7;

FIG. 13 is a diagram illustrating a reciprocal lattice image generated through a Fourier transform process by the wavefront sensor illustrated in FIG. 7;

FIG. 14A is a diagram illustrating lattice points of a target lattice estimated through a target lattice estimation process by the wavefront sensor illustrated in FIG. 7; FIG. 14B is a diagram illustrating lattice coordinates assigned to each target focal spot in focal spot pairing by the wavefront sensor illustrated in FIG. 7; and

FIG. 15A is a diagram illustrating a result of focal spot pairing when a target light is defocused; and FIG. 15B is a diagram illustrating a result of focal spot pairing when the target light includes astigmatism.

### DESCRIPTION OF THE EMBODIMENTS

### Definition of Terms

The embodiment described below relates to a Shack-Hartmann-type wavefront sensor. The Shack-Hartmann-type wavefront sensor is a device for measuring a wavefront aberration of light using a microlens array in which microlenses are arranged in a square lattice pattern.

In the present description, light for which the wavefront aberration is to be measured is referred to as “target light” LP. In addition, collimated light that is used as a reference for measuring the wavefront aberration of the target light LP is referred to as “reference light” LQ.

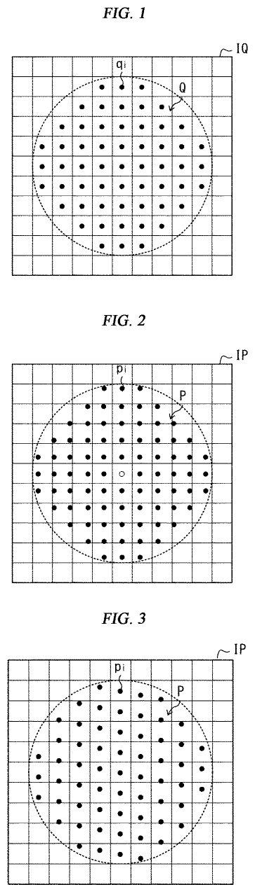

In the present description, a group of focal spots formed by applying a microlens array to the reference light LQ is referred to as “reference focal spot group” Q, and each focal spot belonging to the reference focal spot group Q is referred to as “reference focal spot” qi. Let M be the number of reference focal spots qi, and i be a natural number less than or equal to M. Furthermore, an image representing a two-dimensional distribution (spot diagram) of the reference focal spot group Q is referred to as “reference image” IQ. FIG. 1 is a schematic diagram illustrating one example of the reference image IQ representing the reference focal spot group Q.

Of the reference images IQ, specifically, an image generated by a two-dimensional image sensor when the reference focal spot group Q is formed on the two-dimensional image sensor by applying a microlens array to the reference light LQ is referred to as “original reference image” IQ1.

Each reference focal spot qi belonging to the reference focal spot group Q can be assigned position coordinates r(qi)=(x, y). The position coordinates r(qi) of the reference focal spot qi can be defined, for example, using the pixel coordinates of the pixel where the reference focal spot qi is located among the pixels constituting the reference image IQ. Here, the term “pixel coordinates” refers to coordinates assigned to each pixel of the reference image IQ. The method of assigning pixel coordinates is arbitrary, and as one example, a pixel located at the top-left corner of the reference image IQ may be assigned the coordinates (0, 0), a pixel located x pixels to the right of the pixel at the coordinates (0, 0) may be assigned the coordinates (x, 0), and a pixel located y pixels below the pixel at the coordinates (x, 0) may be assigned the coordinates (x, y). Note that the pixel used as the origin, i.e., the pixel assigned the coordinates (0, 0), is arbitrary. Furthermore, the positive direction of the x-coordinate may be defined as either leftward or rightward, and the positive direction of the y-coordinate may be defined as either upward or downward.

The position coordinates r(qi) of the reference focal spot qi may alternatively be defined using the cell coordinates of the cell where the reference focal spot qi is located among the cells (photoelectric conversion elements) constituting the two-dimensional image sensor. When each pixel constituting the reference image IQ corresponds one-to-one with each cell constituting the two-dimensional image sensor, the position coordinates r(qi) of the reference focal spot qi defined using the pixel coordinates of the reference image IQ coincide with the position coordinates r(qi) of the reference focal spot qi defined using the cell coordinates of the two-dimensional image sensor.

The reference light LQ is collimated light. Therefore, the arrangement of the reference focal spot group Q is approximated by the arrangement of the lattice point group of a square lattice determined based on the positional relationship between each microlens constituting the microlens array and each cell (photoelectric conversion element) constituting the two-dimensional image sensor (see FIG. 1). Hereinafter, a square lattice in which the arrangement of the lattice point group approximates the arrangement of the reference focal spot group Q, that is, a square lattice in which the reference focal spot qi exists in the vicinity of each lattice point, is referred to as “reference lattice” XQ.

The reference lattice XQ, as described above, is determined based on the positional relationship between each microlens constituting the microlens array and each cell (photoelectric conversion element) constituting the two-dimensional image sensor. In other words, the reference lattice XQ is a known lattice in the sense that it can be predetermined before starting the measurement of wavefront aberration. When the ideal reference light LQ without wavefront aberration is measured using an ideal measurement optical system without optical aberration, the arrangement of the reference focal spot group Q coincides with the arrangement of the lattice point group of the reference lattice XQ.

In the present description, a group of focal spots formed by applying a microlens array to the target light LP is referred to as “target focal spot group” P, and each focal spot belonging to the target focal spot group P is referred to as “target focal spot” pi. Let N be the number of target focal spots pi, and i be a natural number less than or equal to N. Furthermore, an image representing the two-dimensional distribution (spot diagram) of the target focal spot group P is referred to as “target image” IP. FIGS. 2 and 3 are schematic diagrams each illustrating one example of the target image IP representing the target focal spot group P.

Of the target images IP, specifically, an image generated by a two-dimensional image sensor when the target focal spot group P is formed on the two-dimensional image sensor by applying a microlens array to the target light LP is referred to as “original target image” IP1. In addition, of the target images IP, specifically, an image obtained by applying a simplification process, which will be described later, to the original target image IP1 is referred to as “simplified target image” IP2.

Each target focal spot pi belonging to the target focal spot group P can be assigned position coordinates r(pi)=(x, y). The position coordinates r(pi) of the target focal spot pi can be defined, for example, using the pixel coordinates of the pixel where the target focal spot pi is located among the pixels constituting the target image IP. Here, the term “pixel coordinates” refers to coordinates assigned to each pixel of the target image IP. The method of assigning pixel coordinates is arbitrary, and as one example, a pixel located at the top-left corner of the target image IP may be assigned the coordinates (0, 0), a pixel located x pixels to the right of the pixel at the coordinates (0, 0) may be assigned the coordinates (x, 0), and a pixel located y pixels below the pixel at the coordinates (x, 0) may be assigned the coordinates (x, y). Note that the pixel used as the origin, i.e., the pixel assigned the coordinates (0, 0), is arbitrary. Furthermore, the positive direction of the x-coordinate may be defined as either leftward or rightward, and the positive direction of the y-coordinate may be defined as either upward or downward.

The position coordinates r(pi) of the target focal spot pi may alternatively be defined using the cell coordinates of the cell where the target focal spot pi is located among the cells (photoelectric conversion elements) constituting the two-dimensional image sensor. When each pixel constituting the target image IP corresponds one-to-one with each cell constituting the two-dimensional image sensor, the position coordinates r(pi) of the target focal spot pi defined using the pixel coordinates of the target image IP coincide with the position coordinates r(pi) of the target focal spot pi defined using the cell coordinates of the two-dimensional image sensor.

The arrangement of the target focal spot group P in the target image IP is determined based not only on the positional relationship between each microlens constituting the microlens array and each cell (photoelectric conversion element) constituting the two-dimensional image sensor, but also on the wavefront aberration of the target light LP. For example, when the target light LP is convergent light, the arrangement of the target focal spot group P is approximated by the arrangement of the lattice point group of a square lattice having a smaller lattice spacing than that of the above-described reference lattice XQ (see FIG. 2). When the target light LP is divergent light, the arrangement of the target focal spot group P is approximated by the arrangement of the lattice point group of a square lattice having a larger lattice spacing than that of the above-described reference lattice XQ. Further, when the target light LP includes astigmatism (for example, in a case of the light which has passed through a cylindrical lens), the arrangement of the target focal spot group P is approximated by the arrangement of the lattice point group of a general lattice (a lattice whose unit cell is a parallelogram) (see FIG. 3). Hereinafter, a lattice in which the arrangement of the lattice point group approximates the arrangement of the target focal spot group P, that is, a lattice in which the target focal spot pi exists in the vicinity of each lattice point, is referred to as “target lattice” XP.

As described above, the target lattice XP is determined based not only on the positional relationship between each microlens constituting the microlens array and each cell (photoelectric conversion element) constituting the two-dimensional image sensor, but also on the wavefront aberration of the target light LP. In other words, the target lattice XP is an unknown lattice in the sense that it cannot be predetermined before starting the measurement of wavefront aberration. In the embodiment described below, the target lattice XP is derived from a reciprocal lattice XR obtained by performing a two-dimensional Fourier transform on the target focal spot group P.

### Problem to be Solved in Embodiment

In order to measure the wavefront aberration of the target light LP, it is necessary to determine a movement amount δ(qi, pi) from the reference focal spot qi, which is formed by the same microlens as the target focal spot pi, to the target focal spot pi, for each target focal spot pi belonging to the target focal spot group P. Therefore, in order to measure the wavefront aberration of the target light LP, it is necessary to pair, for each target focal spot pi belonging to the target focal spot group P, the reference focal spot qi which is formed by the same microlens as the target focal spot pi.

Conventionally, a method of dividing the reference image IQ and the target image IP into blocks has been used for such pairing. The reference image IQ can be divided into a plurality of blocks by vertical and horizontal grid lines arranged at equal intervals, such that a lattice point of a reference lattice XR is positioned at the center of each block (see FIG. 1). The target image IP can also be divided into a plurality of blocks using the same grid lines as those used to divide the reference image IQ (see FIGS. 2 and 3).

When the wavefront aberration of the target light LP is sufficiently small, a method of selecting the reference focal spot qi that belongs to the same block as the target focal spot pi can be adopted as a method of selecting the reference focal spot qi to be paired with each target focal spot pi. This is because, as the wavefront aberration of the target light LP is smaller, the position of each target focal spot pi is closer to the position of the reference focal spot qi formed by the same microlens as the target focal spot pi. Thus, the reason is that when the wavefront aberration of the target light LP is sufficiently small, it is guaranteed that the block to which each target focal spot pi belongs in the target image IP coincides with the block to which the reference focal spot qi, which is formed by the same microlens as the target focal spot pi, belongs in the reference image IQ.

On the other hand, when the wavefront aberration of the target light LP is large, a method of selecting the reference focal spot qi that belongs to the same block as the target focal spot pi cannot be adopted as a method of selecting the reference focal spot qi to be paired with each target focal spot pi. This is because, as the wavefront aberration of the target light LP is larger, the position of each target focal spot pi is farther from the position of the reference focal spot qi formed by the same microlens as the target focal spot pi. Thus, the reason is that when the wavefront aberration of the target light LP is large, it is not guaranteed that the block to which each target focal spot pi belongs in the target image IP coincides with the block to which the reference focal spot qi, which is formed by the same microlens as the target focal spot pi, belongs in the reference image IQ.

The embodiment described below has been made in view of the above-described problem, and its object is to provide a method for pairing the target focal spot pi and the reference focal spot qi formed by the same microlens, regardless of the magnitude of the wavefront aberration of the target light LP. Another object of the embodiment is to provide a method for deriving a wavefront aberration amount (e.g., Zernike coefficient) representing the wavefront aberration of the target light LP using the movement amount d (qi, pi) from the paired reference focal spot qi to the target focal spot pi.

### [Configuration of Computing Device]

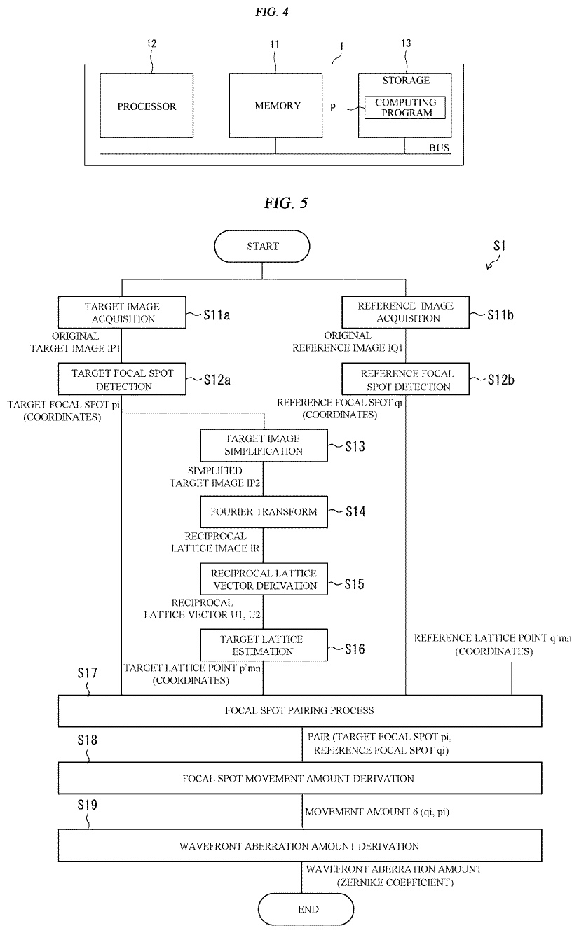

A configuration of a computing device 1 according to one embodiment of the present invention will be described with reference to FIG. 4. FIG. 4 is a block diagram illustrating the configuration of the computing device 1.

In the present embodiment, a single general-purpose computer is used as the computing device 1. As illustrated in FIG. 4, the computing device 1 includes a memory 11, a processor 12, and a storage 13, and executes a computing method S1 described later.

The memory 11, the processor 12, and the storage 13 are interconnected via a bus which is not illustrated. An input/output interface and a communication interface, both of which are not illustrated, may also be connected to this bus.

The input/output interface is used, for example, to input information into the computing device 1 from an external device (e.g., a keyboard), or to output information from the computing device 1 to an external device (e.g., a display). The communication interface is used, for example, to receive information from an external device (e.g., another computer), or to transmit information to an external device (e.g., another computer). The acquisition of the original target image IP1 and the original reference image IQ1 is performed, for example, via the input/output interface or the communication interface.

The memory 11 is configured to temporarily store (e.g., in a volatile manner) a computing program P. The memory 11 is also used to temporarily store various types of data acquired or generated during the execution of the computing method S1 described later, such as the original target image IP1 and the simplified target image IP2. As the memory 11, for example, a semiconductor RAM (Random Access Memory) can be used.

The processor 12 is configured to execute each step included in the computing method S1 described later, in accordance with the computing program P loaded into the memory 11. As the processor 12, for example, a CPU (Central Processing Unit), a GPU (Graphics Processing Unit), a TPU (Tensor Processing Unit), a digital signal processor, a microprocessor, a microcontroller, or a combination thereof can be used.

The storage 13 is configured to non-temporarily store (e.g., in a non-volatile manner) the computing program P. The storage 13 is also used to non-temporarily store various types of data acquired or generated during the execution of the computing method S1 described later, such as the original target image IP1 and the simplified target image IP2. The processor 12 loads the computing program P, which is stored non-temporarily in the storage 13, into the memory 11 for reference. The same applies to various types of data acquired or generated during the execution of the computing method S1 described later, such as the original target image IP1 and the simplified target image IP2. As the storage 13, for example, a flash memory, an HDD (Hard Disk Drive), an SSD (Solid State Drive), or a combination thereof can be used.

In the present embodiment, a configuration is adopted in which a single processor (e.g., the processor 12) provided in a single computer executes the computing method S1, but the present invention is not limited thereto. That is, a configuration may also be adopted in which a plurality of processors, either concentrated in a single computer or distributed across a plurality of computers, cooperatively executes the computing method S1.

The computing program P for causing the processor 12 to execute the computing method S1 may be recorded on a computer-readable, non-transitory, tangible recording medium. This recording medium may be the memory 11, the storage 13, or another recording medium. For example, a tape, a disk, a card, a semiconductor memory, or a programmable logic circuit may be used as the another recording medium.

### [Flow of Computing Method]

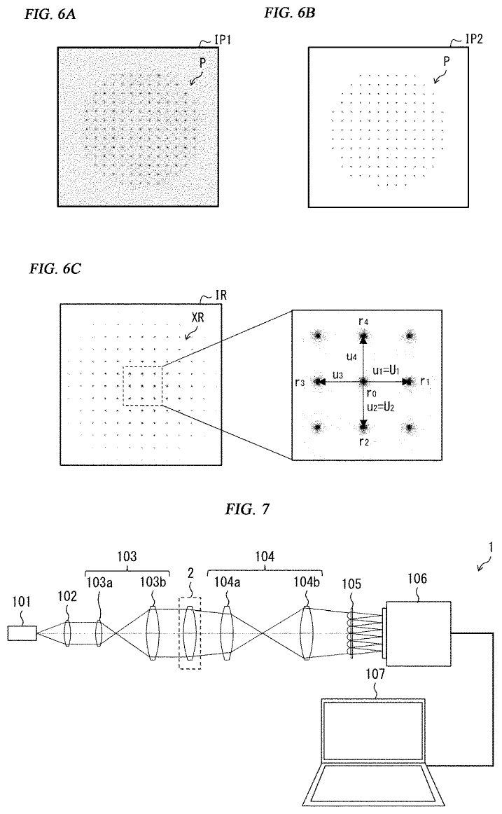

The flow of the computing method S1 according to one embodiment of the present invention will be described with reference to FIG. 5 and FIGS. 6A to 6C. FIG. 5 is a flowchart illustrating the flow of the computing method S1. FIGS. 6A to 6C are schematic diagrams illustrating specific examples of the original target image IP1, the simplified target image IP2, and a reciprocal lattice image IR that are used in the computing method S1.

As illustrated in FIG. 5, the computing method S1 includes: a target image acquisition process S11a, a reference image acquisition process S11b, a target focal spot detection process S12a, a reference focal spot detection process S12b, a target image simplification process S13, a Fourier transform process $14, a reciprocal lattice vector derivation process S15, a target lattice estimation process S16, a focal spot pairing process S17, a focal spot movement amount derivation process S18, and a wavefront aberration amount derivation process S19. In the present embodiment, each process included in the computing method S1 is executed by the processor 12 of the computing device 1.

The target image acquisition process S11a is a process for acquiring the original target image IP1. As described above, the original target image IP1 refers to an image generated by a two-dimensional image sensor when the target focal spot group P is formed on the two-dimensional image sensor by applying a microlens array to the target light LP. One example of the original target image IP1 is illustrated in FIGS. 6A to 6C. Note that the original target image IP1 illustrated in FIGS. 6A to 6C is a black-and-white inverted version of the actual original target image IP1.

The reference image acquisition process S11b is a process for acquiring the original reference image IQ1. As described above, the original reference image IQ1 refers to an image generated by a two-dimensional image sensor when the reference focal spot group Q is formed on the two-dimensional image sensor by applying a microlens array to the reference light LQ.

The target focal spot detection process S12a is a process in which, with reference to the original target image IP1 acquired in the target image acquisition process S11a, each target focal spot pi belonging to the target focal spot group P is detected and the position coordinates r(pi) of each target focal spot pi are identified. As an algorithm for detecting each target focal spot pi and identifying the position coordinates r(pi) of each target focal spot pi in the original target image IP1, a known peak detection algorithm may be used, for example. Here, the algorithm for detecting each target focal spot pi and identifying the position coordinates r(pi) of each target focal spot pi in the original target image IP1 is not limited to this and may be selected arbitrarily.

The reference focal spot detection process S12b is a process in which, with reference to the original reference image IQ1 acquired in the reference image acquisition process S11b, each reference focal spot qi belonging to the reference focal spot group Q is detected and the position coordinates r(qi) of each reference focal spot qi are identified. As an algorithm for detecting each reference focal spot qi and identifying the position coordinates r(qi) of each reference focal spot qi in the original reference image IQ1, a known peak detection algorithm may be used, for example. However, the algorithm for detecting each reference focal spot qi and identifying the position coordinates r(qi) of each reference focal spot qi in the original reference image IQ1 is not limited to this and may be selected arbitrarily.

The position coordinates r(qi) of each reference focal spot qi belonging to the reference focal spot group Q are determined according to the positional relationship between each microlens constituting the microlens array and each cell (photoelectric conversion element) constituting the two-dimensional image sensor, as well as the optical aberration of the optical system constituting the wavefront sensor, and are invariant. Therefore, the reference image acquisition process S11b and the reference focal spot detection process S12b only need to be executed during the first measurement, and need not be executed in the second and subsequent measurements. Furthermore, the reference focal spot group Q is approximated by the lattice point group of the known reference lattice XQ. Accordingly, the position coordinates r(qi) of each reference focal spot qi belonging to the reference focal spot group Q may be substituted by the position coordinates of the respective lattice points of the known reference lattice XQ. In this case, even in the first measurement, the reference image acquisition process S11b and the reference focal spot detection process S12b may be omitted.

The target image simplification process S13 is a process for generating the simplified target image IP2 by simplifying the original target image IP1 acquired in the target image acquisition process S11a. The simplified target image IP2 may be, for example, a binary image in which a pixel corresponding to each target focal spot pi takes a pixel value of “1”, and all the other pixels take a pixel value of “0”. Alternatively, the simplified target image IP2 may be a binary image in which each pixel in the vicinity of the target focal spot pi takes a pixel value of “1”, and all the other pixels take a pixel value of “0”. Here, the term “vicinity of the target focal spot pi” refers to, for example, a circular region centered on the pixel, or a rectangular region centered on the pixel. Additionally, a multi-level image may be used as the simplified target image IP2, in which the pixel corresponding to the target focal spot pi takes the maximum pixel value, pixels in the vicinity of the target focal spot pi take intermediate pixel values depending on the distance from the target focal spot pi, and all the other pixels take the minimum pixel value. As the function for determining the intermediate pixel values, any decreasing function may be used. One example of the simplified target image IP2 is illustrated in FIGS. 6A to 6C. Note that the simplified target image IP2 illustrated in FIGS. 6A to 6C is a black-and-white inverted version of the actual simplified target image IP2.

The simplified target image IP2 can be regarded as an image obtained by removing uneven information such as electronic noise and brightness differences of target focal spots from the original target image IP1. Performing the following processes using the simplified target image IP2 results in higher processing accuracy than performing the same processes using the original target image IP1.

The Fourier transform process S14 is a process for generating the reciprocal lattice image IR by performing a two-dimensional Fourier transform on the simplified target image IP2 generated in the target image simplification process S13. In general, when a two-dimensional Fourier transform is applied to an image representing a point group that is approximately periodically arranged, i.e., a point group approximated by the lattice point group of a two-dimensional lattice, an image representing the lattice point group of the reciprocal lattice corresponding to the two-dimensional lattice is obtained. When the arrangement of the target focal spot group P represented by the simplified target image IP2 is approximated by the arrangement of the lattice point group of a certain target lattice XP, the reciprocal lattice image IR generated in the Fourier transform process S14 represents the lattice point group of the reciprocal lattice XR corresponding to the target lattice XP. One example of the reciprocal lattice image IR is illustrated in FIGS. 6A to 6C. Note that the reciprocal lattice image IR illustrated in FIGS. 6A to 6C is a black-and-white inverted version of the actual reciprocal lattice image IR.

The reciprocal lattice vector derivation process S15 is a process for deriving lattice vectors U₁ and U₂ of the reciprocal lattice XR with reference to the reciprocal lattice image IR generated in the Fourier transform process S14. As can be seen from the enlarged view of the reciprocal lattice image IR illustrated in FIGS. 6A to 6C, the reciprocal lattice image IR has the following characteristics. First, at the center of the reciprocal lattice image IR, there is a lattice point r₀ of the reciprocal lattice XR. Second, in the vicinity of the lattice point r₀ of the reciprocal lattice XR, there are four lattice points r₁, r₂, r₃, and r₄, which are the nearest lattice points to the lattice point r₀ in the reciprocal lattice XR. Accordingly, in the reciprocal lattice vector derivation process S15, four vectors u1, u2, u3, and u4 are first identified, each having the lattice point r₀ as the starting point and one respective lattice point of the four lattice points r1, r2, 3, and r4 as the endpoint. Among the four identified vectors u1, u2, u3, and u4, two linearly independent vectors are selected as the lattice vectors U₁ and U₂ of the reciprocal lattice XR.

The target lattice estimation process S16 is a process for estimating the target lattice XP in which the arrangement of the lattice point group approximates the arrangement of the target focal spot group P, with reference to the lattice vectors U₁ and U₂ of the reciprocal lattice XR derived in the reciprocal lattice vector derivation process S15. In the target lattice estimation process S16, first, (a) with reference to the lattice vectors U₁ and U₂ of the reciprocal lattice XR derived in the reciprocal lattice vector derivation process S15, the lattice vectors V₁ and V₂ of the target lattice XP are derived; next, (b) with reference to the lattice vectors V₁ and V₂ of the target lattice XP, a lattice point p′ₘₙ of the target lattice XP is derived.

To derive the lattice vectors V₁ and V₂ of the target lattice XP, for example, the following formulae (1) and (2) may be used. In the following formulae (1) and (2), R represents a matrix defined by the following formula (3).

$$[ Formula 1 ]$$

$${V}_{1} = \frac{{RU}_{2}}{{U}_{1} \cdot {RU}_{2}} \qquad ( 1 )$$

$$[ Formula 2 ]$$

$${V}_{2} = \frac{{RU}_{1}}{{U}_{2} \cdot {RU}_{1}} \qquad ( 2 )$$

$$[ Formula 3 ]$$

$$R = [ \begin{matrix}0 & - 1 \\ 1 & 0\end{matrix} ] \qquad ( 3 )$$

To derive the lattice point p′ₘₙ of the target lattice XP, for example, the following formula (4) may be used. Here, (m, n) represents the lattice coordinates of the lattice point p′ₘₙ of the target lattice XP.

$$[ Formula 4 ]$$

$${p}_{mn}^{′} = m {V}_{1} + {nV}_{2} \qquad ( 4 )$$

On the other hand, with respect to the reference lattice XQ, in which the arrangement of lattice point group approximates the arrangement of the reference focal spot group Q, a lattice point q′ₘₙ having the lattice coordinates (m, n) is given by the following formula (5). In the following formula (5), lattice vectors W₁ and W₂ represent the lattice vectors of the reference lattice XQ, which are determined based on the positional relationship between each microlens constituting the microlens array and each cell (photoelectric conversion element) constituting the two-dimensional image sensor.

$$[ Formula 5 ]$$

$${q}_{mn}^{′} = m {W}_{1} + {nW}_{2} \qquad ( 5 )$$

Here, the lattice vectors W₁ and W₂ of the reference lattice XQ may be derived based on the positional relationship between each microlens constituting the microlens array and each cell (photoelectric conversion element) constituting the two-dimensional image sensor, or may be derived with reference to the reference image IQ. As a method for deriving the lattice vectors W₁ and W₂ of the reference lattice XQ with reference to the reference image IQ, the same method for deriving the lattice vectors U₁ and U₂ of the reciprocal lattice XR with reference to the reciprocal lattice image IR may be used.

As described above, in the reciprocal lattice vector derivation process S15, the four vectors u1, u2, u3, and u4 illustrated in FIGS. 6A to 6C are identified. The lattice vectors U₁ and U₂ of the reciprocal lattice XR, as previously described, are selected from the four vectors u1, u2, u3, and u4 such that they are linearly independent of each other and also satisfy the following conditions. Condition 1: among the four vectors V₁, V₂, −V₁, and −V₂, the lattice vector V₁ of the target lattice XP derived from the lattice vectors U₁ and U₂ of the reciprocal lattice XR according to formula (1) is the vector that forms the smallest angle with the lattice vector W₁ of the reference lattice XQ. Condition 2: among the four vectors V₁, V₂, −V₁, and −V₂, the lattice vector V₂ of the target lattice XP derived from the lattice vectors U₁ and U₂ of the reciprocal lattice XR according to formula (2) is the vector that forms the smallest angle with the lattice vector W₂ of the reference lattice XQ.

The focal spot pairing process S17 is a process for pairing each target focal spot pi detected in the target focal spot detection process S12a with each reference focal spot qi detected in the reference focal spot detection process S12b. In the focal spot pairing process S17: (a) each target focal spot pi detected in the target focal spot detection process S12a is assigned the lattice coordinates (m, n) of the lattice point p′ₘₙ which is closest to the target focal spot pi among the lattice points of the target lattice XP; (b) each reference focal spot qi detected in the reference focal spot detection process S12b is assigned the lattice coordinates (m, n) of the lattice point q′ₘₙ which is closest to the reference focal spot qi among the lattice points of the reference lattice XR; and then (c) the target focal spot pi and the reference focal spot qi that have been assigned the same lattice coordinates (m, n) are paired together.

When a distance d between the target focal spot pi and the lattice point p′m, which is closest to the target focal spot pi, of the target lattice XP satisfies the following formula (6), the corresponding reference focal spot qi is regarded as nonexistent, and pairing is not performed. This serves as an exception handling measure for cases in which a focal spot is missing, due to, for example, the presence of an optical obstruction within the optical system or the inability to detect a particular focal spot owing to differences in brightness among focal spots.

$$[ Formula 6 ]$$

$$d > \frac{\vert {V}_{1} + {V}_{2} \vert}{2} \qquad ( 6 )$$

The focal spot movement amount derivation process S18 is a process for deriving, for each pair formed in the focal spot pairing process S17, the movement amount δ(qi, pi)=r(pi)−r(qi) from the reference focal spot qi that constitutes the pair to the target focal spot pi that constitutes the pair. Here, r(pi) indicates the position coordinates of the target focal spot pi as identified in the target focal spot detection process S12a. In addition, r(qi) indicates the position coordinates of the reference focal spot qi as identified in the reference focal spot detection process S12b.

The wavefront aberration amount derivation process S19 is a process for deriving a wavefront aberration amount representing the wavefront aberration of the target light LP with reference to each movement amount δ(qi, pi) derived in the focal spot movement amount derivation process S18. Examples of the wavefront aberration amount derived in the wavefront aberration amount derivation process S19 include Zernike coefficients. Since algorithms for deriving Zernike coefficients from the respective movement amounts δ(qi, pi) derived in the focal spot movement amount derivation process S18 are already known in the art, the detailed description thereof is omitted here.

### [Configuration of Wavefront Sensor]

The configuration of a wavefront sensor 100 according to one embodiment of the present invention will be described with reference to FIG. 7. FIG. 7 is a block diagram illustrating a main part configuration of the wavefront sensor 100.

The wavefront sensor 100 is a device for measuring the wavefront aberration of light that has passed through an inspection target 2. The wavefront sensor 100 includes a measurement light source 101, a collimator lens 102, a beam expander 103, a relay optical system 104, a microlens array 105, a two-dimensional image sensor 106, and a computing device 107.

The collimator lens 102, the beam expander 103, the relay optical system 104, the microlens array 105, and the two-dimensional image sensor 106 are arranged in this order along the optical path of a light L output from the measurement light source 101. The inspection target 2 is arranged between the beam expander 103 and the relay optical system 104.

The measurement light source 101 is configured to generate the monochromatic light L. As the measurement light source 101, for example, an LED (Light Emitting Diode), an SLD (Super Luminescent Diode), or an LD (Laser Diode) may be used. The collimator lens 102 is configured to collimate the light L emitted from the measurement light source 101. The beam expander 103 is configured to expand the beam diameter of the light L emitted from the collimator lens 102 to approximately the same size as the inspection target 2. The beam expander 103 includes, for example, two convex lenses 103a and 103b having different focal lengths. The light emitted from the collimator lens 102 and the light L emitted from the beam expander 103 are both collimated light.

The relay optical system 104 is configured to relay the light L emitted from the beam expander 103. The relay optical system 104 includes, for example, two convex lenses 104a and 104b having equal focal lengths. The microlens array 105 includes a plurality of microlenses arranged in a square lattice pattern. Each microlens constituting the microlens array 105 focuses the light L emitted from the relay optical system 104 onto the two-dimensional image sensor 106. Thus, a focal spot group, which is a group of focal spots formed by the respective microlenses constituting the microlens array 105, is formed on the two-dimensional image sensor 106.

The two-dimensional image sensor 106 is configured to generate a two-dimensional image representing the focal spot group formed by the microlens array 105. As the two-dimensional image sensor 106, for example, a CCD (Charge Coupled Device) sensor or a CMOS (Complementary Metal Oxide Semiconductor) sensor may be used. The two-dimensional image generated by the two-dimensional image sensor 106 is transmitted to the computing device 107.

When the inspection target 2 is not arranged between the beam expander 103 and the relay optical system 104, the light L having no wavefront aberration, i.e., the above-described reference light LQ, which is emitted from the beam expander 103 is incident on the microlens array 105 via the relay optical system 104, and the above-described reference focal spot group Q is formed on the two-dimensional image sensor 106. The above-described original reference image IQ1 is the two-dimensional image generated by the two-dimensional image sensor 106 at this time.

On the other hand, when the inspection target 2 is arranged between the beam expander 103 and the relay optical system 104, the light L having wavefront aberration, i.e., the above-described target light LP, which has passed through the inspection target 2 is incident on the microlens array 105 via the relay optical system 104, and the above-described target focal spot group P is formed on the two-dimensional image sensor 106. The above-described original target image IP1 is the two-dimensional image generated by the two-dimensional image sensor 106 at this time.

The computing device 107 is configured to measure the wavefront aberration of the target light LP with reference to the original target image IP1 and the original reference image IQ1 generated by the two-dimensional image sensor 106. The computing device 107 may be implemented using the above-described computing device 1. By executing the above-described computing method S1, the computing device 107 calculates a wavefront aberration amount (e.g., Zernike coefficient) representing the wavefront aberration of the target light LP.

It should be noted that in FIG. 7, a convex lens is illustrated as the inspection target 2, but the invention is not limited thereto. For example, a concave lens may be used as the inspection target 2, or a lens having refractive power in only one direction, such as a cylindrical lens, may be used as the inspection target 2. Furthermore, any optical elements that transmit light, or a combination thereof, can be used as the inspection target 2.

### [Modification 1 of Wavefront Sensor]

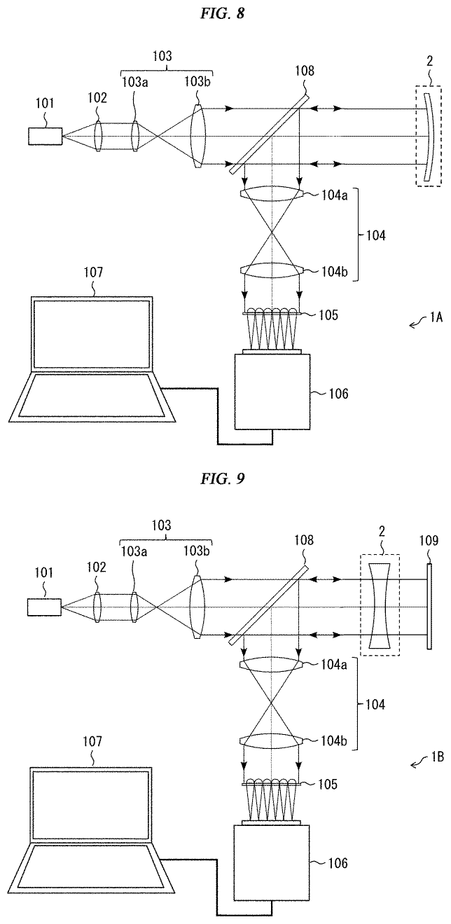

A first modification of the above-described wavefront sensor 100 (hereinafter referred to as wavefront sensor 100A) will be described with reference to FIG. 8. FIG. 8 is a block diagram illustrating a main part configuration of the wavefront sensor 100A.

The wavefront sensor 100A is a device for measuring the wavefront aberration of light reflected by the inspection target 2. The wavefront sensor 100A is a modification of the above-described sensor 100, in which a beam splitter 108 is additionally provided.

The collimator lens 102, the beam expander 103, and the beam splitter 108 are arranged in this order along the optical path of the light L output from the measurement light source 101. The inspection target 2 is arranged on the optical path of the light L that has passed through the beam splitter 108 after being emitted from the beam expander 103. The relay optical system 104, the microlens array 105, and the two-dimensional image sensor 106 are arranged in this order along the optical path of the light L that is reflected by the inspection target 2 and then reflected by the beam splitter 108.

When the inspection target 2 is arranged on the optical path of the light L that has passed through the beam splitter 108, the light L having wavefront aberrations, i.e., the above-described target light LP, which is reflected by the inspection target 2 is incident on the microlens array 105 via the beam splitter 108 and the relay optical system 104, and the above-described target focal spot group P is formed on the two-dimensional image sensor 106. The above-described original target image IP1 is the two-dimensional image generated by the two-dimensional image sensor 106 at this time.

When a plane mirror is arranged on the optical path of the light L that has passed through the beam splitter 108 instead of the inspection target 2, the light L having no wavefront aberration, i.e., the above-described reference light LQ, which is reflected by the plane mirror is incident on the microlens array 105 via the beam splitter 108 and the relay optical system 104, and the above-described reference focal spot group Q is formed on the two-dimensional image sensor 106. The above-described original reference image IQ1 is the two-dimensional image generated by the two-dimensional image sensor 106 at this time.

The computing device 107 is configured to measure the wavefront aberration of the target t light LP with reference to the original target image IP1 and the original reference image IQ1 generated by the two-dimensional image sensor 106. The computing device 107 may be implemented using the above-described computing device 1. By executing the above-described computing method S1, the computing device 107 calculates a wavefront aberration amount (e.g., Zernike coefficient) representing the wavefront aberration of the target light LP.

Note that although a concave mirror is illustrated as the inspection target 2 in FIG. 8, the invention is not limited thereto. For example, a convex mirror may also be used as the inspection target 2. Any optical element that reflects light may be used as the inspection target 2.

### [Modification 2 of Wavefront Sensor]

A second modification of the above-described wavefront sensor 100 (hereinafter referred to as wavefront sensor 100B) will be described with reference to FIG. 9. FIG. 9 is a block diagram illustrating a main part configuration of the wavefront sensor 100B.

The wavefront sensor 100B is a device for measuring the wavefront aberration of light that has passed through the inspection target 2. The wavefront sensor 100B is a modification of the above-described wavefront sensor 100, in which the beam splitter 108 and a plane mirror 109 are additionally provided.

The collimator lens 102, the beam expander 103, and the beam splitter 108 are arranged in this order along the optical path of the light L output from the measurement light source 101. The plane mirror 109 is arranged on the optical path of the light L that has passed through the beam splitter 108 after being emitted from the beam expander 103. The relay optical system 104, the microlens array 105, and the two-dimensional image sensor 106 are arranged in this order along the optical path of the light L that is reflected by the plane mirror 109 and then reflected by the beam splitter 108. The inspection target 2 is arranged between the beam splitter 108 and the plane mirror 109.

When the inspection target 2 is arranged between the beam splitter 108 and the plane mirror 109, the light L which has wavefront aberrations and has passed through the inspection target 2, i.e., the above-described target light LP, is incident on the microlens array 105 via the beam splitter 108 and the relay optical system 104, and the above-described target focal spot group P is formed on the two-dimensional image sensor 106. The above-described original target image IP1 is the two-dimensional image generated by the two-dimensional image sensor 106 at this time.

When the inspection target 2 is not arranged between the beam splitter 108 and the plane mirror 109, the light L which has no wavefront aberration and has been reflected by the plane mirror 109, i.e., the above-described reference light LQ, is incident on the microlens array 105 via the beam splitter 108 and the relay optical system 104, and the above-described reference focal spot group Q is formed on the two-dimensional image sensor 106. The above-described original reference image IQ1 is the two-dimensional image generated by the two-dimensional image sensor 106 at this time.

The computing device 107 is configured to measure the wavefront aberration of the target light LP with reference to the original target image IP1 and the original reference image IQ1 generated by the two-dimensional image sensor 106. The computing device 107 may be implemented using the above-described computing device 1. By executing the above-described computing method S1, the computing device 107 calculates a wavefront aberration amount (e.g., Zernike coefficient) representing the wavefront aberration of the target light LP.

It should be noted that in FIG. 9, a concave lens is illustrated as the inspection target 2, but the invention is not limited thereto. For example, a convex lens may also be used as the inspection target 2. Any optical elements that transmit light, or a combination thereof, can be used as the inspection target 2.

### [Modification 3 of Wavefront Sensor]

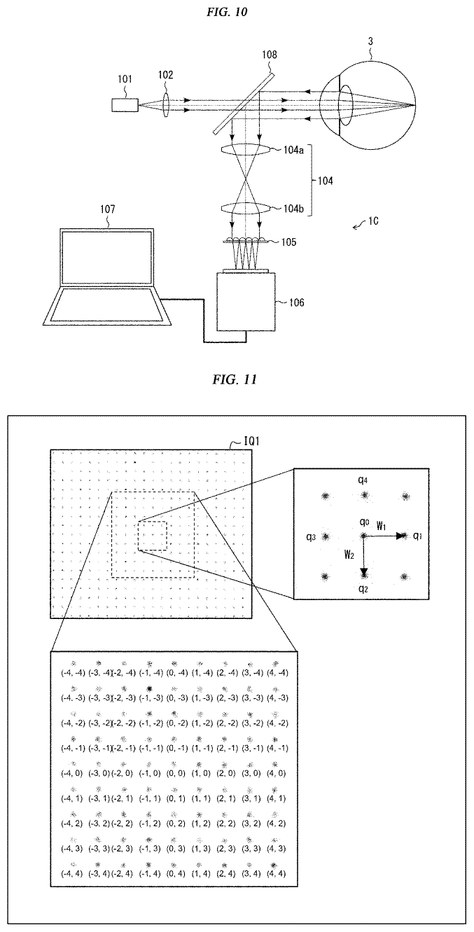

A third modification of the above-described wavefront sensor 100 (hereinafter referred to as wavefront sensor 100C) will be described with reference to FIG. 10. FIG. 10 is a block diagram illustrating a main part configuration of the wavefront sensor 100C.

The wavefront sensor 100C is an ophthalmic wavefront sensor configured to measure the refractive state and optical wavefront aberration of an eye 3 of a human. The wavefront sensor 100C is a modification of the above-described wavefront sensor 100, in which the beam expander 103 is omitted and the beam splitter 108 is additionally provided.

The collimator lens 102 and the beam splitter 108 are arranged in this order along the optical path of the light L output from the measurement light source 101. The light L emitted from the collimator lens 102 and transmitted through the beam splitter 108 is incident on the eye 3 via a pupil. The light L which is incident on the eye 3 passes through intermediate transparent media such as a cornea, a crystalline lens, and a vitreous body, and undergoes scattered reflection on a retina. As a result, each point on the retina functions as a secondary point light source. The light L emitted from each point on the retina again passes through the intermediate transparent media and is emitted from the eye 3 via the pupil. The relay optical system 104, the microlens array 105, and the two-dimensional image sensor 106 are arranged in this order along the optical path of the light L that is emitted from the eye 3 and then reflected by the beam splitter 108.

When the eye 3 is arranged on the optical path of the light L that has passed through the beam splitter 108, the light L which has wavefront aberrations and is emitted from each point on the retina and transmitted through the intermediate transparent media, i.e., the above-described target light LP, is incident on the microlens array 105 via the beam splitter 108 and the relay optical system 104, and the above-described target focal spot group P is formed on the two-dimensional image sensor 106. The above-described original target image IP1 is the two-dimensional image generated by the two-dimensional image sensor 106 at this time.

When a test optical system that reflects aberration-free plane waves is arranged on the optical path of the light L transmitted through the beam splitter 108 instead of the eye 3, the light L which has no wavefront aberration and is reflected by the test optical system, i.e., the above-described reference light LQ, is incident on the microlens array 105 via the beam splitter 108 and the relay optical system 104, and the above-described reference focal spot group Q is formed on the two-dimensional image sensor 106. The above-described original reference image IQ1 is the two-dimensional image generated by the two-dimensional image sensor 106 at this time.

The computing device 107 is configured to measure the wavefront aberration of the target light LP with reference to the original target image IP1 and the original reference image IQ1 generated by the two-dimensional image sensor 106. The computing device 107 may be implemented using the above-described computing device 1. By executing the above-described computing method S1, the computing device 107 calculates a wavefront aberration amount (e.g., Zernike coefficient) representing the wavefront aberration of the target light LP.

The refractive state of the eye 3 of the human varies widely, and the components of the measured wavefront aberration are mainly defocus and astigmatism. The amount of defocus corresponds to the degree of myopia or hyperopia, and the amount of astigmatism corresponds to the degree of astigmatism. According to the wavefront sensor 100C, it is possible to perform measurement over a very wide range, even in cases of large individual differences in the degrees of myopia, hyperopia, and astigmatism, without requiring correction of the optical system.

### [Operation Example of Wavefront Sensor]

An operation example of the above-described wavefront sensor 100 will be described with reference to FIG. 11 to FIGS. 15A and 15B.

FIG. 11 is a diagram illustrating the original reference image IQ1 acquired by the wavefront sensor 100 through the reference image acquisition process S11b when the inspection target 2 is not arranged, with black and white inverted.

As illustrated in FIG. 11, the arrangement of the reference focal spot group Q in the original reference image IQ1 is approximated by the arrangement of the lattice point group of the reference lattice XQ. The lattice vectors W₁ and W₂ of the reference lattice XQ are illustrated in an enlarged view (on the right side) of the vicinity of the center of the original reference image IQ1. Additionally, the lattice coordinates (m, n) assigned to each reference focal spot qi belonging to the reference focal spot group Q are illustrated in the enlarged view (on the lower side) around the center of the original reference image IQ1.

FIG. 12A is a diagram illustrating the original target image IP1 acquired by the wavefront sensor 100 through the target image acquisition process S11a when the inspection target 2 is arranged, with black and white inverted. FIG. 12B is a diagram illustrating the simplified target image IP2 generated by the wavefront sensor 100 through the target image simplification process S13, with black and white inverted.

As illustrated in FIGS. 12A and 12B, the arrangement of the target focal spot group P in the original target image IP1 and the simplified target image IP2 is approximated by the arrangement of the lattice point group of the target lattice XP.

It can be seen from FIGS. 12A and 12B that no target focal spot pi exists in the peripheral regions of the original target image IP1 and the simplified target image IP2. This is due to the aperture limitation in the wavefront sensor 100. Furthermore, it can also be seen from FIG. 12B that there are missing portions in the simplified target image IP2 where no target focal spot pi is present. This is because a low-luminance target focal spot pi may fail to be detected in the target focal spot detection process S12a.

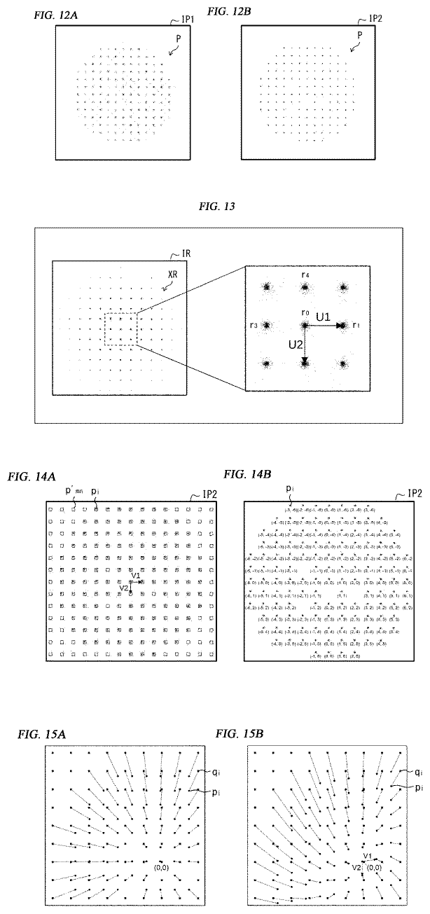

FIG. 13 is a diagram illustrating the reciprocal lattice image IR generated by the wavefront sensor 100 through the Fourier transform process S14, with black and white inverted.

As illustrated in FIG. 13, even when the simplified target image IP2 has missing portions where no target focal spot pi is present, a complete reciprocal lattice IR can still be formed in the reciprocal lattice image IR. The lattice vectors U₁ and U₂ of the reciprocal lattice XR obtained through the reciprocal lattice vector derivation process S15 are illustrated in an enlarged view of the vicinity of the center of the reciprocal lattice image IR.

FIG. 14A is a diagram in which the lattice points P′ₘₙ (white squares) of the target lattice XP estimated by the wavefront sensor through the target lattice estimation process S16 are overlaid on the simplified target image IP2 illustrated in FIG. 12B. FIG. 14B is a diagram in which the lattice coordinates (m, n) assigned to each target focal spot pi by the wavefront sensor 100 in the focal spot pairing process S17 are overlaid on the simplified target image IP2 illustrated in FIG. 12B.

As illustrated in FIG. 14B, it can be seen that even when there are missing portions in the simplified target image IP2 where no target focal spot pi is present, the lattice coordinates (m, n) are correctly assigned to each target focal spot pi belonging to the target focal spot group P.

FIG. 15A is a diagram illustrating a result of the focal spot pairing process S17 in a case where the target light LP is defocused (where a convex lens is used as the inspection target 2). In FIG. 15A, each reference focal spot qi belonging to the reference focal spot group Q is represented by a black-filled square, each target focal spot pi belonging to the target focal spot group P is represented by a black-filled circle, and paired reference focal spots qi and target focal spots pi are connected by broken lines. The reference focal spot qi assigned with the lattice coordinates (0, 0) is the reference focal spot qi closest to the optical center. It can be seen that the reference focal spots qi and the target focal spots pi are correctly paired.

FIG. 15B is a diagram illustrating a result of the focal spot pairing process S17 in a case where the target light LP has astigmatism (where a cylindrical lens is used as the inspection target 2). In FIG. 15B, each reference focal spot qi belonging to the reference focal spot group Q is represented by a black-filled square, each target focal spot pi belonging to the target focal spot group P is represented by a black-filled circle, and paired reference focal spots qi and target focal spots pi are connected by broken lines. The reference focal spot qi assigned with the lattice coordinates (0, 0) is the reference focal spot qi closest to the optical center. It can be seen that even when the lattice vectors V₁ and V₂ of the target lattice XR are not orthogonal to each other, the reference focal spots qi and the target focal spots pi are correctly paired.

### SUMMARY

### (Aspect 1)

A computing device is configured to execute:
a reference focal spot detection process that refers to a reference image representing a reference focal spot group formed by applying a microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of a lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of a lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and a wavefront aberration amount derivation process that refers to each movement amount derived in the focal spot movement amount derivation process and derives a wavefront aberration amount representing a wavefront aberration of the target light.

### (Aspect 2)

The computing device according to aspect 1 is further configured to execute a target image simplification process that generates a simplified target image by simplifying an original target image generated by a two-dimensional image sensor when the target focal spot group has been formed on the two-dimensional image sensor by applying the microlens array to the target light, wherein a target image referred to in the Fourier transform process is the simplified target image generated through the target image simplification process.

### (Aspect 3)

The computing device according to aspect 1 or 2, wherein, in the target lattice estimation process, (a) lattice vectors V₁ and V₂ of the target lattice are derived in accordance with formula (1) and formula (2) below using a matrix R defined by formula (3) below with reference to lattice vectors U₁ and U₂ of the reciprocal lattice; and (b) a lattice point p′m of the target lattice is derived in accordance with formula (4) below with reference to the lattice vectors V₁ and V₂ of the target lattice.

$$[ Formula 7 ]$$

$${V}_{1} = \frac{{RU}_{2}}{{U}_{1} \cdot {RU}_{2}} \qquad ( 1 )$$

$$[ Formula 8 ]$$

$${V}_{2} = \frac{{RU}_{1}}{{U}_{2} \cdot {RU}_{1}} \qquad ( 2 )$$

$$[ Formula 9 ]$$

$$R = [ \begin{matrix}0 & - 1 \\ 1 & 0\end{matrix} ] \qquad ( 3 )$$

$$[ Formula 10 ]$$

$${p}_{mn}^{′} = m {V}_{1} + {nV}_{2} \qquad ( 4 )$$

### (Aspect 4)

A computing method includes:
a reference focal spot detection process that refers to a reference image representing a reference focal spot group formed by applying the microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of a lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of a lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and a wavefront aberration amount derivation process that refers to each movement amount derived in the focal spot movement amount derivation process and derives a wavefront aberration amount representing a wavefront aberration of the target light.

### (Aspect 5)

A computing program causes at least one processor to execute:
a reference focal spot detection process that refers to a reference image representing a reference focal spot group formed by applying a microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of a lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of a lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and
a wavefront aberration amount derivation process that refers to each movement amount derived in the focal spot movement amount derivation process and derives a wavefront aberration amount representing a wavefront aberration of the target light.

### (Aspect 6)

A wavefront sensor includes:
a computing device according to any one of aspects 1 to 3;
the microlens array; and
a two-dimensional image sensor configured to generate the target image and the reference image.

### Supplementary Notes

The present disclosure includes the techniques described in the following supplementary notes. Here, the present disclosure is not limited to the techniques described in the following supplementary notes, and various modifications may be made.

1. A computing device configured to execute:
a reference focal spot detection process that refers to a reference image representing a reference focal spot group formed by applying a microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of the lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of the lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and
a wavefront aberration amount derivation process that refers to each movement amount derived in the focal spot movement amount derivation process and derives a wavefront aberration amount representing a wavefront aberration of the target light.

2. The computing device according to claim 1, further configured to execute:
a target image simplification process that generates a simplified target image by simplifying an original target image generated by a two-dimensional image sensor when the target focal spot group has been formed on the two-dimensional image sensor by applying the microlens array to the target light, wherein
a target image referred to in the Fourier transform process is the simplified target image generated through the target image simplification process.

3. The computing device according to claim 1, wherein,
in the target lattice estimation process, (a) lattice vectors V₁ and V₂ of the target lattice are derived in accordance with formula (1) and formula (2) below using a matrix R defined by formula (3) below with reference to lattice vectors U₁ and U₂ of the reciprocal lattice; and (b) a lattice point p′ₘₙ of the target lattice is derived in accordance with formula (4) below with reference to the lattice vectors V₁ and V₂ of the target lattice,
$$[ Formula 1 ]$$
$${V}_{1} = \frac{{RU}_{2}}{{U}_{1} \cdot {RU}_{2}} \qquad ( 1 )$$
$$[ Formula 2 ]$$
$${V}_{2} = \frac{{RU}_{1}}{{U}_{2} \cdot {RU}_{1}} \qquad ( 2 )$$
$$[ Formula 3 ]$$
$$R = [ \begin{matrix}0 & - 1 \\ 1 & 0\end{matrix} ] \qquad ( 3 )$$
$$[ Formula 4 ]$$
$${p}_{mn}^{′} = m {V}_{1} + {nV}_{2} . \qquad ( 4 )$$

4. A computing method comprising:
a reference focal spot detection process that refers to a reference image representing a reference focal spot group formed by applying a microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of the lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of the lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and
a wavefront aberration amount derivation process that refers to each movement amount derived in the focal spot movement amount derivation process and derives a wavefront aberration amount representing a wavefront aberration of the target light.

5. A computing program causing at least one processor to execute:
a reference focal spot detection process that refers to a reference image representing a reference focal spot group formed by applying a microlens array to a reference light and detects each reference focal spot belonging to the reference focal spot group;
a target focal spot detection process that refers to a target image representing a target focal spot group formed by applying the microlens array to a target light and detects each target focal spot belonging to the target focal spot group;
a Fourier transform process that performs a two-dimensional Fourier transform on the target image to generate a reciprocal lattice image representing a lattice point group of a reciprocal lattice;
a reciprocal lattice vector derivation process that refers to the reciprocal lattice image generated in the Fourier transform process and derives a lattice vector of the reciprocal lattice;
a target lattice estimation process that refers to the lattice vector of the reciprocal lattice derived in the reciprocal lattice vector derivation process and estimates a target lattice in which an arrangement of the lattice point group approximates an arrangement of the target focal spot group;
focal spot pairing including: (a) assigning to each target focal spot detected in the target focal spot detection process lattice coordinates of a lattice point, which is closest to the target focal spot, among lattice points of the target lattice estimated in the target lattice estimation process, (b) assigning to each reference focal spot detected in the reference focal spot detection process lattice coordinates of a lattice point, which is closest to the reference focal spot, among lattice points of a reference lattice in which an arrangement of the lattice point group approximates an arrangement of the reference focal spot group, and then (c) pairing a target focal spot and a reference focal spot to which identical lattice coordinates have been assigned;
a focal spot movement amount derivation process that derives, for each pair formed in the focal spot pairing, a movement amount from a reference focal spot forming the pair to a target focal spot forming the pair; and
a wavefront aberration amount derivation process that refers to each movement amount derived in the focal spot movement amount derivation process and derives a wavefront aberration amount representing a wavefront aberration of the target light.

6. A wavefront sensor comprising:
a computing device according to claim 1;
the microlens array; and
a two-dimensional image sensor configured to generate the target image and the reference image.

7. A wavefront sensor comprising:
a computing device according to claim 2;
the microlens array; and
a two-dimensional image sensor configured to generate the target image and the reference image.

8. A wavefront sensor comprising:
a computing device according to claim 3;
the microlens array; and
a two-dimensional image sensor configured to generate the target image and the reference image.
